(19) United States
(12) Patent Application Publication
(10) Pub. No.: US 2026/0323395 A1
(43) Pub. Date: Oct. 15, 2026

(54) WIRELESS COMMUNICATION METHOD AND APPARATUS, COMMUNICATION DEVICE AND STORAGE MEDIUM

(71) Applicant: Beijing Xiaomi Mobile Software Co., Ltd., Beijing (CN)

(72) Inventors: Yang SHEN, Beijing (CN); Jinhua WU, Beijing (CN); Deqian WANG, Beijing (CN)

(73) Assignee: Beijing Xiaomi Mobile Software Co., Ltd., Beijing (CN)

(21) Appl. No.: 18/996,916

(22) PCT Filed: Jul. 25, 2022
(86) PCT No.: PCT/CN2022/107719

§ 371 Date: Jan. 17, 2025

(51) Int. Cl. H04W 28/18; H04W 8/24

(52) U.S. Cl. CPC H04W 28/18; H04W 8/24

(57) ABSTRACT

The embodiments of the present disclosure provide a wireless communication method. The method is executed by a base station, and the method comprises: according to terminal state information of a terminal, using the quality of service (QoS) level of a first service corresponding to the terminal state information. In this way, the QoS level can adapt to the terminal state, which can achieve balance between QoE and the terminal state of the terminal compared with a mode in which the QoS level is not updated on the basis of the terminal state, thereby improving user experience.

### CROSS-REFERENCE TO RELATED APPLICATIONS

This application is a national stage of International Application No. PCT/CN2022/107719, filed on Jul. 25, 2022, which is hereby incorporated by reference in its entirety.

### TECHNICAL FIELD

The present disclosure relates to, but is not limited to, the technical field of wireless communication, and in particular, to a wireless communication method and apparatus, a communication device, and a storage medium.

### BACKGROUND

With the development of wireless networks, more efficient data flow coding/decoding solutions require more power consumption and higher reliability, also, higher throughput and lower latency budget also require more power consumption and more network resources. Hence, trade-off of quality of experience (QoE) and device power consumption needs to be considered. In related arts, there is no corresponding policy mechanism to meet the above requirements.

### SUMMARY

Embodiments of the present disclosure provide a wireless communication method and apparatus, a communication device and a storage medium.

According to a first aspect of the embodiments of the present disclosure, a wireless communication method is provided, performed by a base station, including: enforcing, according to terminal status information of a terminal, a quality of service (QoS) level of a first service corresponding to the terminal status information; where the terminal status information indicates a terminal status.

According to a second aspect of the embodiments of the present disclosure, a wireless communication method is provided, performed by a terminal, including: sending terminal status information of the terminal to a base station; where the terminal status information is used by the base station to enforce a quality of service (QoS) level of a first service corresponding to the terminal status information.

According to a third aspect of the embodiments of the present disclosure, a wireless communication method is provided, performed by a core network, including: sending quality of service (QoS) level information of a QoS flow bound to a first service to a base station; where the QoS level information indicates target QoS and alternative QoS; and the QoS level information is used by the base station to enforce, based on terminal status information, a QoS level of a first service corresponding to the terminal status information.

According to a fourth aspect of the embodiments of the present disclosure, a wireless communication method is provided, performed by an application server, including: sending quality of service (QoS) requirement information to a core network; where the QoS requirement information indicates a QoS requirement of a first service; and the QoS requirement of the first service includes a target QoS requirement and one or more alternative QoS requirements.

According to a fifth aspect of the embodiments of the present disclosure, a communication device is provided, including: a processor; and a memory for storing an instruction executable by the processor; where the processor is configured to execute the executable instruction to implement the method according to any embodiment of the present disclosure.

According to a sixth aspect of the embodiments of the present disclosure, a computer storage medium is provided, storing a computer-executable program, where when the computer-executable program is executed by a processor, the method according to any embodiment of the present disclosure is implemented.

In the embodiments of the present disclosure, the quality of service (QoS) level of the first service corresponding to the terminal status information is enforced according to terminal status information of the terminal. Herein, since the QoS level enforced by the base station is the QoS level of the first service corresponding to the terminal status information, the QoS level may be adapted to the terminal status, and compared with a manner in which the QoS level is not updated based on the terminal status, a balance between QoE and the terminal status of the terminal may be implemented and user experience may be improved.

### BRIEF DESCRIPTION OF DRAWINGS

FIG. 1 is a schematic structural diagram of a wireless communication system according to an example embodiment.

FIG. 2A is a schematic flowchart of a wireless communication method according to an example embodiment.

FIG. 2B is a schematic scenario diagram of an aware service according to an example embodiment.

FIG. 3 is a schematic flowchart of a wireless communication method according to an example embodiment.

FIG. 4 is a schematic flowchart of a wireless communication method according to an example embodiment.

FIG. 5 is a schematic flowchart of a wireless communication method according to an example embodiment.

FIG. 6 is a schematic flowchart of a wireless communication method according to an example embodiment.

FIG. 7 is a schematic flowchart of a wireless communication method according to an example embodiment.

FIG. 8 is a schematic flowchart of a wireless communication method according to an example embodiment.

FIG. 9 is a schematic flowchart of a wireless communication method according to an example embodiment.

FIG. 10 is a schematic flowchart of a wireless communication method according to an example embodiment.

FIG. 11 is a schematic flowchart of a wireless communication method according to an example embodiment.

FIG. 12 is a schematic flowchart of a wireless communication method according to an example embodiment.

FIG. 13 is a schematic flowchart of a wireless communication method according to an example embodiment.

FIG. 14 is a schematic flowchart of a wireless communication method according to an example embodiment.

FIG. 15 is a schematic flowchart of a wireless communication method according to an example embodiment.

FIG. 16 is a schematic flowchart of a wireless communication method according to an example embodiment.

FIG. 17 is a schematic flowchart of a wireless communication method according to an example embodiment.

FIG. 18 is a schematic flowchart of a wireless communication method according to an example embodiment.

FIG. 19 is a schematic structural diagram of a wireless communication apparatus according to an example embodiment.

FIG. 20 is a schematic structural diagram of a wireless communication apparatus according to an example embodiment.

FIG. 21 is a schematic structural diagram of a wireless communication apparatus according to an example embodiment.

FIG. 22 is a schematic structural diagram of a wireless communication apparatus according to an example embodiment.

FIG. 23 is a schematic structural diagram of a terminal according to an example embodiment.

FIG. 24 is a block diagram of a base station according to an example embodiment.

### DETAILED DESCRIPTION

Example embodiments will be described in detail herein, examples of which are illustrated in the accompanying drawings. When following description refers to the drawings, unless otherwise indicated, same numerals in different drawings indicate same or similar elements. The embodiments described in the following example embodiments do not represent all embodiments consistent with the embodiments of the present disclosure. Rather, they are merely examples of apparatuses and methods consistent with some aspects of the embodiments of the present disclosure as detailed in the appended claims.

The terminology used in the embodiments of the present disclosure is for the purpose of describing particular embodiments only and is not intended to limit the embodiments of the present disclosure. The singular forms “a/an”, “the”, and “said” used in the embodiments of the present disclosure and the appended claims are also intended to include plural forms unless the context clearly indicates other meanings. It should also be understood that the term “and/or” as used herein refers to and includes any or all possible combinations of one or more associated listed item.

It should be understood that although the terms “first”, “second”, “third”, etc., may be used in the embodiments of the present disclosure to describe various information, these information should not be limited to these terms. These terms are only used to distinguish a same type of information from each other. For example, “first information” may also be referred to as “second information” without departing from the scope of the embodiments of the present disclosure, and similarly, the “second information” may also be referred to as “first information”. Depending on context, the word “if” as used herein may be interpreted as “when” or “upon” or “in response to determining”.

For purposes of brevity and ease of understanding, the terms “greater than” or “less than” are used herein for characterizing magnitude relation. However, for a person skilled in the art, it may be understood that the term “greater than” also covers “greater than or equal to”, and “less than” also covers “less than or equal to”.

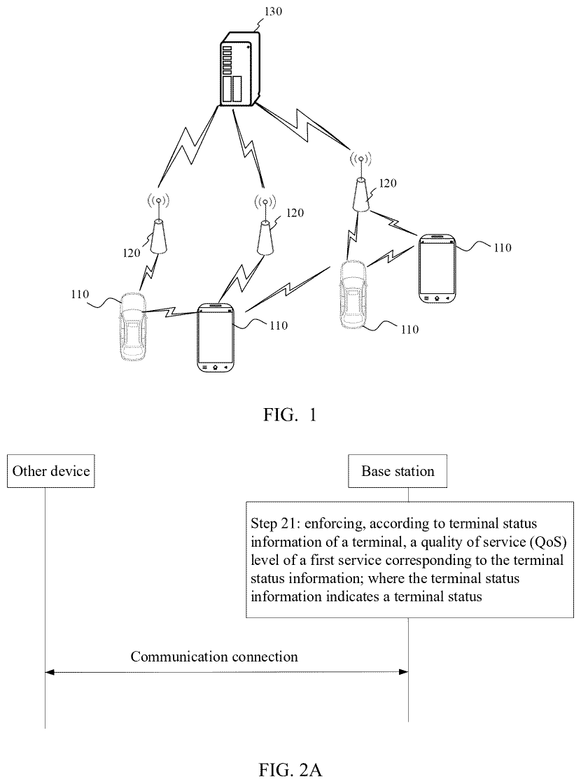

As shown in FIG. 1, FIG. 1 is a schematic structural diagram of a wireless communication system according to an embodiment of the present disclosure. As shown in FIG. 1, the wireless communication system is a communication system based on a mobile communication technology, and the wireless communication system may include: several user equipments 110 and several base stations 120.

The user equipment 110 may be a device that provides voice and/or data connectivity to a user. The user equipment 110 may communicate with one or more core networks through a radio access network (RAN), and the user equipment 110 may be Internet of Things user equipment, such as a sensor device, a mobile phone, and a computer having Internet of Things user equipment, which may be, for example, a fixed, portable, pocket-sized, handheld, computer built-in, or vehicle-mounted apparatus. For example, a station (STA), a subscriber unit, a subscriber station, a mobile station, a mobile, a remote station, an access point, a remote terminal, an access terminal, a user terminal, a user agent, a user device, or a user equipment. Alternatively, the user equipment 110 may be a device of an unmanned aerial vehicle. Alternatively, the user equipment 110 may be an in-vehicle device, for example, may be an automotive computer having a wireless communication function, or may be wireless user equipment externally connected to an automotive computer. Alternatively, the user equipment 110 may be roadside equipment, for example, a street lamp, a signal light, or other roadside equipment having a wireless communication function.

The base station 120 may be a network side device in a wireless communication system. The wireless communication system may be a 4th generation mobile communication (4G) system, also referred to as a long term evolution (LTE) system; or the wireless communication system may be a 5G system, also referred to as a new radio system or a 5G NR system. Alternatively, the wireless communication system may be a next-generation system of a 5G system. The access network in the 5G system may be referred to as an NG-RAN (New Generation-Radio Access Network).

The base station 120 may be an evolved NodeB (eNB) used in a 4G system. Alternatively, the base station 120 may be a base station (gNB) using a centralized distributed architecture in a 5G system. When using a centralized-distributed architecture, the base station 120 usually includes a central unit (CU) and at least two distributed units (DUs). A protocol stack of a packet data convergence protocol (PDCP) layer, a radio link control (RLC) layer, and a media access control (MAC) layer is disposed in the central unit; and a protocol stack of a physical (PHY) layer is disposed in the distributed unit, and a specific implementation of the base station 120 is not limited in the embodiments of the present disclosure.

A wireless connection may be established between the base station 120 and the user equipment 110 through a wireless air interface. In different embodiments, the wireless air interface may be a wireless air interface based on a fourth generation mobile communication network technology (4G) standard; or the wireless air interface may be a wireless air interface based on a fifth generation mobile communication network technology (5G) standard, for example, the wireless air interface is a new air interface; or the wireless air interface may be a wireless air interface based on a next generation of 5G mobile communication network technology standard.

In some embodiments, an E2E (End to End) connection may be further established between the user equipments 110. For example, in scenarios of vehicle-to-vehicle (V2V) communication, vehicle-to-infrastructure (V2I) communication, and vehicle-to-pedestrian (V2P) communication in vehicle-to-everything (V2X) communication.

Herein, the user equipment may be considered as a terminal device in the following embodiments.

In some embodiments, the wireless communication system may further include a network management device 130.

The several base stations 120 are respectively connected to the network management device 130. The network management device 130 may be a core network device in the wireless communication system, for example, the network management device 130 may be a mobility management entity (MME) in an evolved packet core (EPC). Alternatively, the network management device may be another core network device, for example, a serving gateway (SGW), a public data network gateway (PGW), a policy and charging rules function (PCRF) unit, or a home subscriber server (HSS). An implementation of the network management device 130 is not limited in the embodiments of the present disclosure.

In order to facilitate understanding of those skilled in the art, the embodiments of the present disclosure list a plurality of implementations to clearly illustrate the technical solutions of the embodiments of the present disclosure. Certainly, those skilled in the art may understand that the multiple embodiments provided by the embodiments of the present disclosure may be executed separately, or may be executed together with methods of other embodiments in the embodiments of the present disclosure after being combined, or may be executed together with some methods in other related technologies after being combined, which is not limited in the embodiments of the present disclosure.

In order to facilitate understanding of the embodiments of the present disclosure, an application scenario of an aware service is described below.

To facilitate understanding of the technical solutions described in any embodiment of the present disclosure, application scenarios in the related art are first described.

Mobile media services, Extended Reality (XR) services such as Augmented Reality (AR) or Virtual Reality (VR), cloud games, video-based machine or unmanned aerial vehicle remote control and other services are expected to contribute higher and higher publicity to 5G networks.

In addition to audio and video flows, XR service involves multi-modal data flows, such as data flows of biological tactile perception. These multi-modal data are data input from a same device or different devices (including sensors) describing a same service or application, and these data may be output to one or more destination device terminals. Each data flow in the multi-modal data often has a certain or even strong correlation, for example, synchronization of audio and video streams, and synchronization of haptics and visuals. The data flows of such media services, among the data flows, and the requirements of these service data flows for network transmission all have some common features, and the effective identification and utilization of these features will be beneficial to transmission and control of the network and service, and will be beneficial to service guarantee and user experience.

However, a 5GS (5G system) uses a general quality of service (QoS) mechanism to process various data services including XR services, and cannot effectively support differentiated uplink and downlink requirements without fully considering XR media service characteristics, for example, asymmetric requirements of uplink data reliability and downlink data bandwidth. In addition, the XR media data flow requires high bandwidth, low latency, and high reliability, resulting in significant power consumption. The power consumption solution is also an important factor affecting service use and user experience.

In an embodiment, various data services including XR services requires high throughput, low latency, and high reliability, and a status of the terminal, such as heating level, battery level, and processor load, which may affect user experience. High throughput requires high power consumption, resulting in high temperature and high processor load in the terminal side. Thus, considering limited radio resources and end-to-end QoS policy control from a system perspective, the 5GS should be enhanced to support tradeoffs between throughput, latency, reliability, and terminal status.

In some embodiments, based on existing UE implementation, multiple schemes may be applied on UE locally based on battery level, for example, a high screen refresh rate is kept for all the service when battery is more than 80%; a medium screen refresh rate is kept for all the service when battery is less than 80%; a few non-mandatory and high power consumption threads or applications are switched off when battery is lower than 20%; and all non-mandatory or high power consumption threads or applications are switched off or disabled when battery is lower than 10%. However, it has never been considered to reduce the QoS level of certain specific services when the battery is low.

In some embodiments, a “UE battery power change” is defined as an access related policy control request triggering and/or a non-access related policy control request triggering. A policy control function (PCF) subscribes to UE battery power change from an access and mobility management function (AMF) or a session management function (SMF). Upon receiving the “UE Battery Level Change” event, the PCF determines a policy according to the current UE Battery Level, e.g., selects a QoS level corresponding to a low or ultra-low battery level for service.

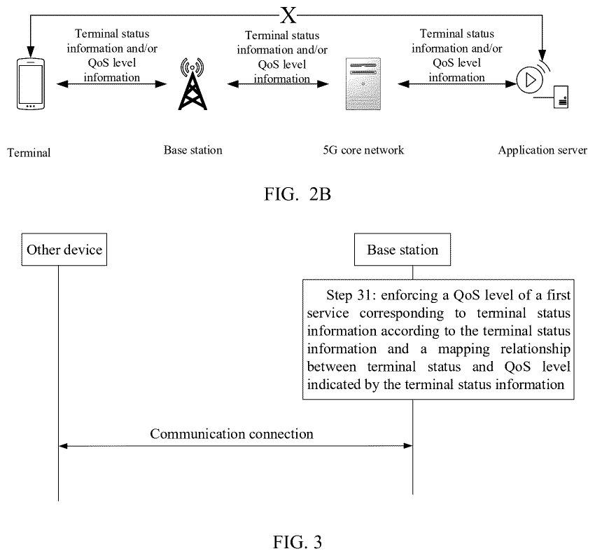

As shown in FIG. 2A, an embodiment provides a wireless communication method, performed by a base station, including step 21.

Step 21: enforcing, according to terminal status information of a terminal, a quality of service (QoS) level of a first service corresponding to the terminal status information; where the terminal status information indicates a terminal status.

It should be noted that the first service is not limited to an extended reality media (XRM) service, a media traffic service, and/or a multi-modal service, which may be various general services or basic services, for example, a terminal service, which is not limited herein.

The terminal involved herein in the embodiments of the present disclosure may be, but is not limited to, a mobile phone, a wearable device, a vehicle-mounted terminal, a Road Side Unit (RSU), a smart home terminal, an industrial sensing device, and/or a medical device. In some embodiments, the terminal may be a Redcap terminal or a new radio (NR) terminal of a predetermined release (for example, an NR terminal of R17).

The base station involved in the present disclosure may be various types of base stations, for example, a base station of a third generation mobile communication (3G) network, a base station of a fourth generation mobile communication (4G) network, a base station of a fifth generation mobile communication (5G) network, or other evolved base stations.

The network function in the present disclosure may be a network function of a core network, and the network function may be a network function of a core network such as 4G or 5G, or may be a network function of another evolved core network, which is not limited herein.

In an embodiment, the terminal status information is information associated with terminal power supply.

In an embodiment, the terminal status information includes at least one of: battery level information; heating level information; or central processing unit (CPU) load information.

In the embodiment of the present disclosure, the QoS level is associated with the QoS parameter, and the QoS parameter herein may include a 5QI (5G QoS Indicator) parameter, a Guaranteed Bit Rate (GBR) and an Aggregated Maximum Bit Rate (AMBR). Herein, the 5G QoS indicator (5QI) parameter includes a priority level, a packet delay budget, a packet error rate, an average window, a maximum data burst volume, and the like.

In an embodiment, the QoS level of the first service is updated according to terminal status information of the terminal.

In an embodiment, the QoS level of the first service corresponding to the terminal status information is enforced according to the terminal status information and a mapping relationship between a terminal status and a QoS level indicated by the terminal status information.

In an embodiment, a mapping relationship between the terminal status and the QoS level indicated by the terminal status information is established. The QoS level of the first service corresponding to the terminal status information is enforced according to the terminal status information and the mapping relationship.

For example, Table 1 is a mapping relationship between the terminal status, a screen refresh rate, the QoS level, and a coding/decoding scheme for application data flows of the first service.

TABLE 1

| | | | Coding/decoding |
|---|---|---|---|
| | Screen | | scheme of |
| | refresh | QoS | application |
| Terminal status | rate | Level | data flow |
| Good (high battery level, best | high | high | high |
| working temperature, and/or low | | | |
| CPU load) | | | |
| Normal (normal battery level, | normal | normal | normal |
| normal working temperature, | | | |
| and/or medium CPU load) | | | |
| Bad (low battery level, | low | low | low |
| overheating, and/or high | | | |
| CPU load) | | | |

It should be noted that for the first service, the application server may provide multiple QoS requirements to the core network function to accommodate different codecs, for example, including a target QoS requirement and one or more alternative QoS requirements. The target QoS requirement and the one or more alternative QoS requirements are to be mapped to a target QoS level and one or more alternative QoS levels by the core network function. The core network function may then provide the target QoS level and the one or more alternative QoS levels to the base station. In such way, the base station can enforce, according to the terminal status information of the terminal, the QoS level of the first service corresponding to the terminal status information. The target QoS level herein may be understood as a level that would be enforced in priority.

In an embodiment, the terminal status information is received. The QoS level of the first service corresponding to the terminal status information is enforced according to the terminal status information of the terminal, where the terminal status information indicates a terminal status. For example, the terminal status information sent by the terminal is received. The QoS level of the first service corresponding to the terminal status information is enforced according to the terminal status information of the terminal, where the terminal status information indicates a terminal status.

In an embodiment, the terminal status information sent by the terminal is received. In response to receiving the terminal status information, the QoS level of the first service corresponding to the terminal status information is enforced according to the terminal status information.

In an embodiment, the terminal status information sent by the terminal is received. In response to receiving the terminal status information and determining that a preset number of resources is less than a threshold, the QoS level of the first service corresponding to the terminal status information is enforced according to the terminal status information.

In an embodiment, the terminal status information sent by the terminal is received. In response to receiving the terminal status information and determining that a required preset number of resources is greater than a threshold, the QoS level of the first service corresponding to the terminal status information is enforced according to the terminal status information.

In an embodiment, the QoS level of the first service corresponding to the terminal status information is enforced according to the terminal status information of the terminal, where the terminal status information indicates a terminal status. In response to changing of the terminal status information or changing of the QoS level of the first service, the current terminal status information of the terminal, or information of the currently enforced QoS level, or both, are sent to a network function of a core network.

In an embodiment, the QoS level of the first service corresponding to the terminal status information is enforced according to the terminal status information of the terminal, where the terminal status information indicates a terminal status. In response to changing of the QoS level of the first service, information of the currently enforced QoS level is sent to the terminal.

In an embodiment, QoS level information sent by a network function of a core network is received, where the QoS level information indicates target QoS and alternative QoS of a QoS flow bound to the first service. The QoS level of the first service corresponding to the terminal status information is enforced according to the terminal status information of the terminal, where the terminal status information indicates a terminal status.

It should be noted that a predetermined service is bound to a QoS flow in the core network, each QoS flow corresponds to a group of QoS parameters, and the QoS parameters reflect a QoS requirement and/or a QoS level of the predetermined service. If different predetermined services have same QoS requirement and/or QoS level, the predetermined services are bound to a same QoS flow.

In an embodiment, QoS level information sent by a network function of a core network is received, where the QoS level information indicates target QoS and alternative QoS of a QoS flow bound to the first service. The terminal status information is received. The QoS level of the first service is modified from the target QoS to the alternative QoS according to the terminal status information of the terminal.

In an embodiment, QoS level information sent by a network function of a core network is received, where the QoS level information indicates target QoS and alternative QoS of a QoS flow bound to the first service. The terminal status information is received. The QoS level of the first service is modified from the alternative QoS to the target QoS according to the terminal status information of the terminal.

In an embodiment, QoS level information sent by a network function of a core network is received, where the QoS level information indicates target QoS and alternative QoS of a QoS flow bound to the first service. The terminal status information is received. The QoS level of the first service is modified from one alternative QoS to another alternative QoS according to the terminal status information of the terminal.

In an embodiment, terminal status management indication information sent by a network function of a core network is received, where the terminal status management indication information indicates that an alternative QoS level is applied to terminal status management. It should be noted that the terminal status management indication information may be generated by a policy control function (PCF), the terminal status management indication information is used as a parameter in the alternative QoS in the policy and charging control (PCC) rule, the PCF sends the terminal status management indication information to a session management function (SMF), and the SMF sends the terminal status management indication information to the base station.

Table 2 shows that the PCF includes terminal status management indication information in the alternative QoS parameter set in the PCC rule.

TABLE 2

| | |
|---|---|
| Alternative QoS | This part defines Alternative QoS Parameter |
| Parameter Sets | Sets for the service data flow |
| Averaging | Averaging window in this Alternative QoS |
| window | Parameter Set |
| Maximum Data | Maximum Data Burst Volume in this |
| Burst Volume | Alternative QoS Parameter Set |
| UE status | Indicates that the alternative QoS applies to |
| management | UE status management (i.e. enforce |
| | alternative QoS based on UE status) |

In an embodiment, FIG. 2B is a schematic diagram of data (terminal status information and/or QoS level information) interaction between the terminal, the base station, the network function of the core network, and an application server.

In an embodiment of the present disclosure, the QoS level of the first service corresponding to the terminal status information is enforced according to the terminal status information of the terminal, where the terminal status information indicates a terminal status. Herein, since the QoS level enforced by the base station is the QoS level of the first service corresponding to the terminal status information, the QoS level may be adapted to the terminal status, and compared with a manner in which the QoS level is not updated based on the terminal status, a balance between QoE and the terminal status of the terminal may be implemented and user experience may be improved.

It should be noted that those skilled in the art may understand that the method provided by the embodiments of the present disclosure may be performed independently, or may be performed together with some methods in the embodiments of the present disclosure or some methods in the related art.

As shown in FIG. 3, an embodiment provides a wireless communication method, performed by a base station, including step 31.

Step 31: enforcing a QoS level of a first service corresponding to terminal status information according to the terminal status information and a mapping relationship between terminal status and QoS level indicated by the terminal status information, where the terminal status information includes at least one of:
battery level information; heating level information; or central processing unit (CPU) load information.

In an embodiment, the terminal status information sent by the terminal is received. The QoS level of the first service corresponding to the terminal status information is enforced according to the terminal status information and the mapping relationship between terminal status and QoS level indicated by the terminal status information. It should be noted that the mapping relationship may include a relationship between the terminal status, a screen refresh rate, the QoS level, and a coding/decoding scheme of application data flows.

In an embodiment, the QoS level of the first service corresponding to the terminal status information is enforced according to the terminal status information and a mapping relationship between a terminal status and a QoS level indicated by the terminal status information.

In an embodiment, a mapping relationship between the terminal status and the QoS level indicated by the terminal status information is established. The QoS level of the first service corresponding to the terminal status information is enforced according to the terminal status information and the mapping relationship.

It should be noted that those skilled in the art may understand that the method provided by the embodiments of the present disclosure may be performed independently, or may be performed together with some methods in the embodiments of the present disclosure or some methods in the related art.

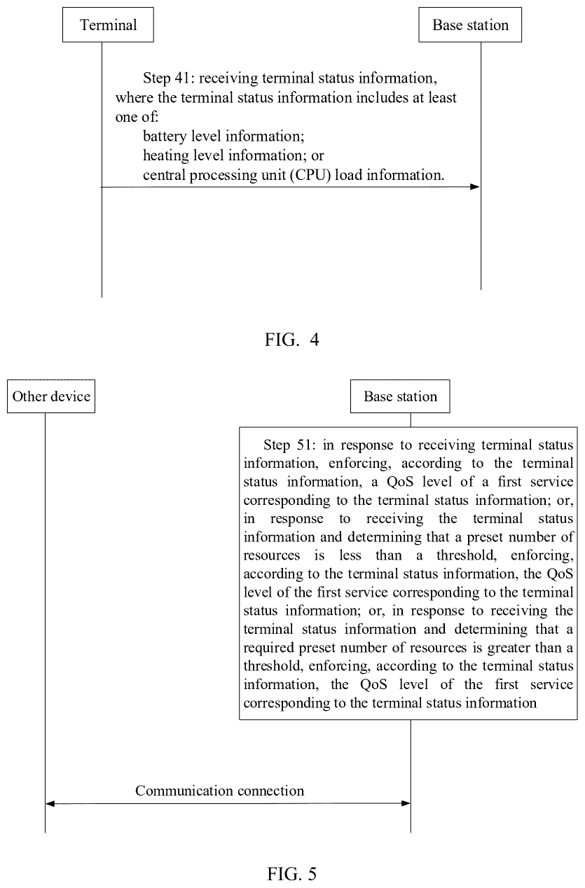

As shown in FIG. 4, an embodiment provides a wireless communication method, performed by a base station, including step 41.

Step 41: receiving terminal status information, where the terminal status information includes at least one of: battery level information; heating level information; or central processing unit (CPU) load information.

In an embodiment, the terminal status information is received. The QoS level of the first service corresponding to the terminal status information is enforced according to the terminal status information of the terminal, where the terminal status information indicates a terminal status. For example, the terminal status information sent by the terminal is received. The QoS level of the first service corresponding to the terminal status information is enforced according to the terminal status information of the terminal, where the terminal status information indicates a terminal status.

In an embodiment, the terminal status information sent by the terminal is received. In response to receiving the terminal status information, the QoS level of the first service corresponding to the terminal status information is enforced according to the terminal status information.

It should be noted that those skilled in the art may understand that the method provided by the embodiments of the present disclosure may be performed independently, or may be performed together with some methods in the embodiments of the present disclosure or some methods in the related art.

As shown in FIG. 5, an embodiment provides a wireless communication method, performed by a base station, including step 51.

Step 51: in response to receiving terminal status information, enforcing, according to the terminal status information, a QoS level of a first service corresponding to the terminal status information; or, in response to receiving the terminal status information and determining that a preset number of resources is less than a threshold, enforcing, according to the terminal status information, the QoS level of the first service corresponding to the terminal status information; or, in response to receiving the terminal status information and determining that a required preset number of resources is greater than a threshold, enforcing, according to the terminal status information, the QoS level of the first service corresponding to the terminal status information.

The terminal status information includes at least one of: battery level information; heating level information; or central processing unit (CPU) load information.

In an embodiment, the terminal status information sent by the terminal is received. In response to receiving the terminal status information, the QoS level of the first service corresponding to the terminal status information is enforced according to the terminal status information.

In an embodiment, the terminal status information sent by the terminal is received. In response to receiving the terminal status information and determining that a preset number of resources is less than a threshold, the QoS level of the first service corresponding to the terminal status information is enforced according to the terminal status information.

In an embodiment, the terminal status information sent by the terminal is received. In response to receiving the terminal status information and determining that a required preset number of resources is greater than a threshold, the QoS level of the first service corresponding to the terminal status information is enforced according to the terminal status information.

It should be noted that those skilled in the art may understand that the method provided by the embodiments of the present disclosure may be performed independently, or may be performed together with some methods in the embodiments of the present disclosure or some methods in the related art.

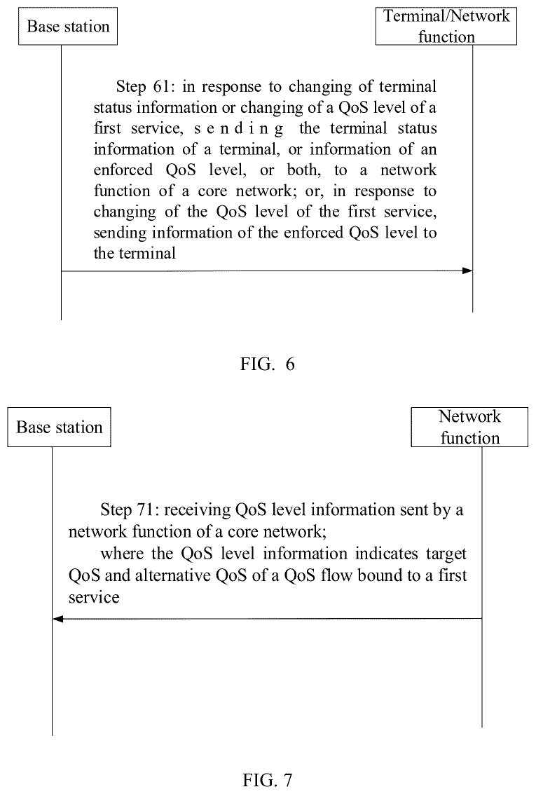

As shown in FIG. 6, an embodiment provides a wireless communication method, performed by a base station, including step 61.

Step 61: in response to changing of terminal status information or changing of a QoS level of a first service, sending the terminal status information of a terminal, or information of an enforced QoS level, or both, to a network function of a core network; or, in response to changing of the QoS level of the first service, sending information of the enforced QoS level to the terminal.

The terminal status information includes at least one of: battery level information; heating level information; or central processing unit (CPU) load information.

In an embodiment, the QoS level of the first service corresponding to the terminal status information is enforced according to the terminal status information of the terminal, where the terminal status information indicates a terminal status. In response to changing of the terminal status information or changing of the QoS level of the first service, the current terminal status information of the terminal, or information of the currently enforced QoS level, or both, are sent to a network function of a core network.

In an embodiment, the QoS level of the first service corresponding to the terminal status information is enforced according to the terminal status information of the terminal, where the terminal status information indicates a terminal status. In response to changing of the QoS level of the first service, information of the currently enforced QoS level is sent to the terminal.

It should be noted that those skilled in the art may understand that the method provided by the embodiments of the present disclosure may be performed independently, or may be performed together with some methods in the embodiments of the present disclosure or some methods in the related art.

As shown in FIG. 7, an embodiment provides a wireless communication method, performed by a base station, including step 71.

Step 71: receiving QoS level information sent by a network function of a core network; where the QoS level information indicates target QoS and alternative QoS of a QoS flow bound to a first service.

In an embodiment, QoS level information sent by a network function of a core network is received, where the QoS level information indicates target QoS and alternative QoS of a QoS flow bound to the first service. The QoS level of the first service corresponding to the terminal status information is enforced according to the terminal status information of the terminal, where the terminal status information indicates a terminal status.

It should be noted that a predetermined service is bound to a QoS flow in the core network, each QoS flow corresponds to a group of QoS parameters, and the QoS parameters reflect a QoS requirement and/or a QoS level of the predetermined service. If different predetermined services have same QoS requirement and/or QoS level, the predetermined services are bound to a same QoS flow.

In the present disclosure, there is only one target QoS, and there may be one or more alternative QoS.

It should be noted that those skilled in the art may understand that the method provided by the embodiments of the present disclosure may be performed independently, or may be performed together with some methods in the embodiments of the present disclosure or some methods in the related art.

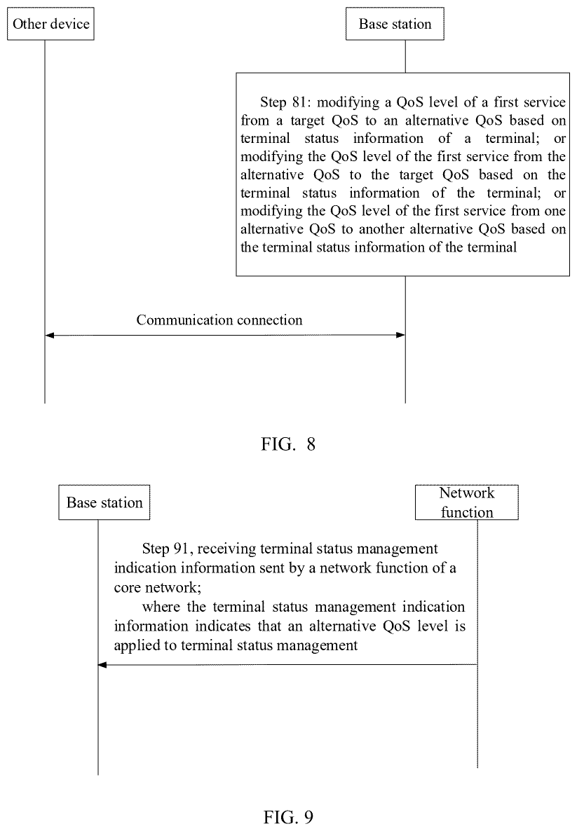

As shown in FIG. 8, an embodiment provides a wireless communication method, performed by a base station, including step 81.

Step 81: modifying a QoS level of a first service from a target QoS to an alternative QoS based on terminal status information of a terminal; or modifying the QoS level of the first service from the alternative QoS to the target QoS based on the terminal status information of the terminal; or modifying the QoS level of the first service from one alternative QoS to another alternative QoS based on the terminal status information of the terminal.

The terminal status information includes at least one of: battery level information; heating level information; or central processing unit (CPU) load information.

In an embodiment, QoS level information sent by a network function of a core network is received, where the QoS level information indicates target QoS and alternative QoS of a QoS flow bound to the first service. The terminal status information is received. The QoS level of the first service is modified from the target QoS to the alternative QoS according to the terminal status information of the terminal.

In an embodiment, QoS level information sent by a network function of a core network is received, where the QoS level information indicates target QoS and alternative QoS of a QoS flow bound to the first service. The terminal status information is received. The QoS level of the first service is modified from the alternative QoS to the target QoS according to the terminal status information of the terminal.

In an embodiment, QoS level information sent by a network function of a core network is received, where the QoS level information indicates target QoS and alternative QoS of a QoS flow bound to the first service. The terminal status information is received. The QoS level of the first service is modified from one alternative QoS to another alternative QoS according to the terminal status information of the terminal.

It should be noted that those skilled in the art may understand that the method provided by the embodiments of the present disclosure may be performed independently, or may be performed together with some methods in the embodiments of the present disclosure or some methods in the related art.

As shown in FIG. 9, an embodiment provides a wireless communication method, performed by a base station, including step 91.

Step 91, receiving terminal status management indication information sent by a network function of a core network; where the terminal status management indication information indicates that an alternative QoS level is applied to terminal status management.

In an embodiment, terminal status management indication information sent by a network function of a core network is received, where the terminal status management indication information indicates that an alternative QoS level is applied to terminal status management. It should be noted that the terminal status management indication information may be generated by a policy control function (PCF), the terminal status management indication information is used as a parameter in the alternative QoS in the policy and charging control (PCC) rule, the PCF sends the terminal status management indication information to a session management function (SMF), and the SMF sends the terminal status management indication information to the base station.

It should be noted that those skilled in the art may understand that the method provided by the embodiments of the present disclosure may be performed independently, or may be performed together with some methods in the embodiments of the present disclosure or some methods in the related art.

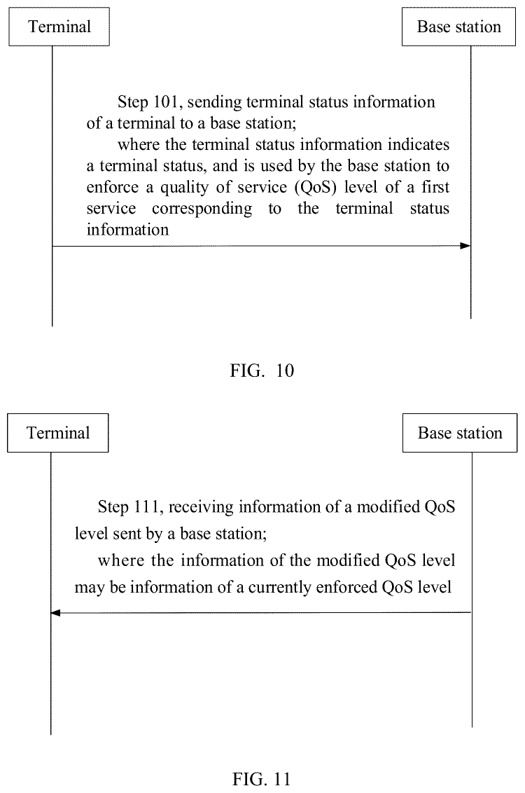

As shown in FIG. 10, an embodiment provides a wireless communication method, performed by a terminal, including step 101.

Step 101, sending terminal status information of a terminal to a base station; where the terminal status information indicates a terminal status, and is used by the base station to enforce a quality of service (QoS) level of a first service corresponding to the terminal status information.

It should be noted that the first service is not limited to an extended reality media (XRM) service, a media traffic service, and/or a multi-modal service, which may be various general services or basic services, for example, a terminal service, which is not limited herein.

The terminal involved herein in the embodiments of the present disclosure may be, but is not limited to, a mobile phone, a wearable device, a vehicle-mounted terminal, a Road Side Unit (RSU), a smart home terminal, an industrial sensing device, and/or a medical device. In some embodiments, the terminal may be a Redcap terminal or a new radio (NR) terminal of a predetermined release (for example, an NR terminal of R17).

The base station involved in the present disclosure may be various types of base stations, for example, a base station of a third generation mobile communication (3G) network, a base station of a fourth generation mobile communication (4G) network, a base station of a fifth generation mobile communication (5G) network, or other evolved base stations.

The network function in the present disclosure may be a network function of a core network, and the network function may be a network function of a core network such as 4G or 5G, or may be a network function of another evolved core network, which is not limited herein.

In an embodiment, the terminal status information is information associated with terminal power supply.

In an embodiment, the terminal status information includes at least one of: battery level information; heating level information; or central processing unit (CPU) load information.

In the embodiment of the present disclosure, the QoS level is associated with the QoS parameter, and the QoS parameter herein may include a 5QI (5G QoS Indicator) parameter, a Guaranteed Bit Rate (GBR) and an Aggregated Maximum Bit Rate (AMBR). Herein, the 5G QoS indicator (5QI) parameter includes a priority level, a packet delay budget, a packet error rate, an average window, a maximum data burst volume, and the like.

In an embodiment, the terminal sends terminal status information of the terminal to the base station, and the base station updates the QoS level of the first service based on the terminal status information of the terminal.

In an embodiment, the terminal sends the terminal status information of the terminal to the base station; the base station enforces the QoS level of the first service corresponding to the terminal status information according to the terminal status information and a mapping relationship between a terminal status and a QoS level indicated by the terminal status information.

In an embodiment, the terminal sends the terminal status information of the terminal to the base station; the base station enforces the QoS level of the first service corresponding to the terminal status information according to the terminal status information and a mapping relationship between a terminal status and a QoS level indicated by the terminal status information. The terminal receives information of the updated and modified QoS level sent by the base station.

It should be noted that those skilled in the art may understand that the method provided by the embodiments of the present disclosure may be performed independently, or may be performed together with some methods in the embodiments of the present disclosure or some methods in the related art.

As shown in FIG. 11, an embodiment provides a wireless communication method, performed by a terminal, including step 111.

Step 111, receiving information of a modified QoS level sent by a base station.

Information of the modified QoS level herein may be information of a currently enforced QoS level.

In an embodiment, the terminal sends the terminal status information of the terminal to the base station; the base station enforces the QoS level of the first service corresponding to the terminal status information according to the terminal status information and a mapping relationship between a terminal status and a QoS level indicated by the terminal status information. The terminal receives information of the updated and modified QoS level sent by the base station.

It should be noted that those skilled in the art may understand that the method provided by the embodiments of the present disclosure may be performed independently, or may be performed together with some methods in the embodiments of the present disclosure or some methods in the related art.

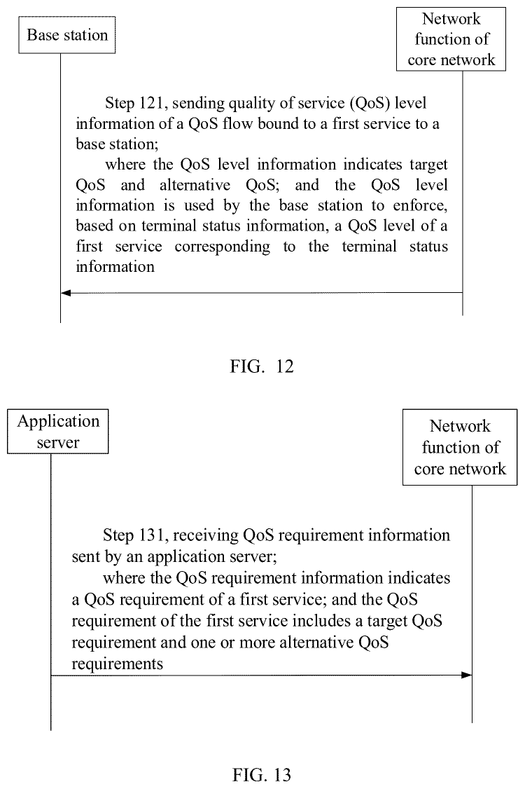

As shown in FIG. 12, an embodiment provides a wireless communication method, performed by a network function of a core network, including step 121.

Step 121, sending quality of service (QoS) level information of a QoS flow bound to a first service to a base station; where the QoS level information indicates target QoS and alternative QoS; and the QoS level information is used by the base station to enforce, based on terminal status information, a QoS level of a first service corresponding to the terminal status information.

It should be noted that the first service is not limited to an extended reality media (XRM) service, a media traffic service, and/or a multi-modal service, which may be various general services or basic services, for example, a terminal service, which is not limited herein.

The terminal involved herein in the embodiments of the present disclosure may be, but is not limited to, a mobile phone, a wearable device, a vehicle-mounted terminal, a Road Side Unit (RSU), a smart home terminal, an industrial sensing device, and/or a medical device. In some embodiments, the terminal may be a Redcap terminal or a new radio (NR) terminal of a predetermined release (for example, an NR terminal of R17).

The base station involved in the present disclosure may be various types of base stations, for example, a base station of a third generation mobile communication (3G) network, a base station of a fourth generation mobile communication (4G) network, a base station of a fifth generation mobile communication (5G) network, or other evolved base stations.

The network function in the present disclosure may be a network function of a core network, and the network function may be a network function of a core network such as 4G or 5G, or may be a network function of another evolved core network, which is not limited herein.

In an embodiment, the terminal status information is information associated with terminal power supply.

In an embodiment, the terminal status information includes at least one of: battery level information; heating level information; or central processing unit (CPU) load information.

In the embodiment of the present disclosure, the QoS level is associated with the QoS parameter, and the QoS parameter herein may include a 5QI (5G QoS Indicator) parameter, a Guaranteed Bit Rate (GBR) and an Aggregated Maximum Bit Rate (AMBR). Herein, the 5G QoS indicator (5QI) parameter includes a priority level, a packet delay budget, a packet error rate, an average window, a maximum data burst volume, and the like.

In an embodiment, QoS requirement information sent by an application server is received; where the QoS requirement information indicates a QoS requirement of the first service, and the QoS requirement of the first service includes a target QoS requirement and one or more alternative QoS requirements. The QoS level information of the QoS flow bound to the first service is sent to the base station; where the QoS level information indicates target QoS and alternative QoS; and the QoS level information is used by the base station to enforce, based on terminal status information, a QoS level of a first service corresponding to the terminal status information.

In an embodiment, QoS requirement information sent by an application server is received; where the QoS requirement information indicates a QoS requirement of the first service, and the QoS requirement of the first service includes a target QoS requirement and one or more alternative QoS requirements. The QoS level of the first service is determined based on the QoS requirement indicated by the QoS requirement information, where the QoS level of the first service includes a target QoS level and one or more alternative QoS levels. The QoS level information of the QoS flow bound to the first service is sent to the base station; where the QoS level information indicates target QoS and alternative QoS; and the QoS level information is used by the base station to enforce, based on terminal status information, a QoS level of a first service corresponding to the terminal status information.

In an embodiment, the QoS level information of the QoS flow bound to the first service is sent to the base station; where the QoS level information indicates target QoS and alternative QoS; and the QoS level information is used by the base station to enforce, based on terminal status information, a QoS level of a first service corresponding to the terminal status information. The current terminal status information of the terminal, or information of the currently enforced QoS level, or both, is received.

In an embodiment, the QoS level information of the QoS flow bound to the first service is sent to the base station; where the QoS level information indicates target QoS and alternative QoS; and the QoS level information is used by the base station to enforce, based on terminal status information, a QoS level of a first service corresponding to the terminal status information. The current terminal status information of the terminal, or information of the currently enforced QoS level, or both, is received. In response to pre-receiving a request for acquiring the terminal status information, or the QoS level, or both, sent by an application server, sending the current terminal status information of the terminal, or the information of the currently enforced QoS level, or both, to the application server. The “pre-receiving a request for acquiring the terminal status information, or the QoS level, or both, sent by an application server” herein may be understood as “the application server subscribes the terminal status information, or the QoS level, or both”.

In an embodiment, terminal status management indication information is sent to the base station, where the terminal status management indication information indicates that an alternative QoS level is applied to terminal status management. The QoS level information of the QoS flow bound to the first service is sent to the base station; where the QoS level information indicates target QoS and alternative QoS; and the QoS level information is used by the base station to enforce, based on terminal status information, a QoS level of a first service corresponding to the terminal status information.

It should be noted that those skilled in the art may understand that the method provided by the embodiments of the present disclosure may be performed independently, or may be performed together with some methods in the embodiments of the present disclosure or some methods in the related art.

As shown in FIG. 13, an embodiment provides a wireless communication method, performed by a network function of a core network, including step 131.

Step 131, receiving QoS requirement information sent by an application server; where the QoS requirement information indicates a QoS requirement of a first service; and the QoS requirement of the first service includes a target QoS requirement and one or more alternative QoS requirements.

In an embodiment, QoS requirement information sent by an application server is received; where the QoS requirement information indicates a QoS requirement of the first service, and the QoS requirement of the first service includes a target QoS requirement and one or more alternative QoS requirements. The QoS level information of the QoS flow bound to the first service is sent to the base station; where the QoS level information indicates target QoS and alternative QoS; and the QoS level information is used by the base station to enforce, based on terminal status information, a QoS level of a first service corresponding to the terminal status information.

In an embodiment, QoS requirement information sent by an application server is received; where the QoS requirement information indicates a QoS requirement of the first service, and the QoS requirement of the first service includes a target QoS requirement and one or more alternative QoS requirements. The QoS level of the first service is determined based on the QoS requirement indicated by the QoS requirement information, where the QoS level of the first service includes a target QoS level and one or more alternative QoS levels. The QoS level information of the QoS flow bound to the first service is sent to the base station; where the QoS level information indicates target QoS and alternative QoS; and the QoS level information is used by the base station to enforce, based on terminal status information, a QoS level of a first service corresponding to the terminal status information.

It should be noted that those skilled in the art may understand that the method provided by the embodiments of the present disclosure may be performed independently, or may be performed together with some methods in the embodiments of the present disclosure or some methods in the related art.

As shown in FIG. 14, an embodiment provides a wireless communication method, performed by a network function of a core network, including step 141.

Step 141, determining a QoS level of a first service based on a QoS requirement indicated by QoS requirement information, where the QoS level of the first service includes a target QoS level and one or more alternative QoS levels.

In an embodiment, QoS requirement information sent by an application server is received; where the QoS requirement information indicates a QoS requirement of the first service, and the QoS requirement of the first service includes a target QoS requirement and one or more alternative QoS requirements. The QoS level of the first service is determined based on the QoS requirement indicated by the QoS requirement information, where the QoS level of the first service includes a target QoS level and one or more alternative QoS levels. The QoS level information of the QoS flow bound to the first service is sent to the base station; where the QoS level information indicates target QoS and alternative QoS; and the QoS level information is used by the base station to enforce, based on terminal status information, a QoS level of a first service corresponding to the terminal status information.

It should be noted that those skilled in the art may understand that the method provided by the embodiments of the present disclosure may be performed independently, or may be performed together with some methods in the embodiments of the present disclosure or some methods in the related art.

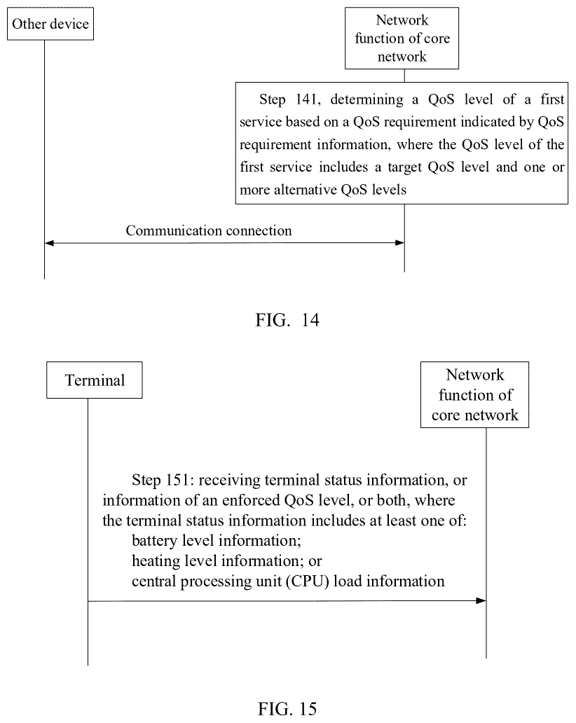

As shown in FIG. 15, an embodiment provides a wireless communication method, performed by a network function of a core network, including step 151.

Step 151: receiving terminal status information, or information of an enforced QoS level, or both, where the terminal status information includes at least one of: battery level information; heating level information; or central processing unit (CPU) load information.

In an embodiment, the QoS level information of the QoS flow bound to the first service is sent to the base station; where the QoS level information indicates target QoS and alternative QoS; and the QoS level information is used by the base station to enforce, based on terminal status information, a QoS level of a first service corresponding to the terminal status information. The current terminal status information of the terminal, or information of the currently enforced QoS level, or both, is received. In response to pre-receiving a request for acquiring the terminal status information, or the QoS level, or both, sent by an application server, sending the current terminal status information of the terminal, or the information of the currently enforced QoS level, or both, to the application server.

It should be noted that those skilled in the art may understand that the method provided by the embodiments of the present disclosure may be performed independently, or may be performed together with some methods in the embodiments of the present disclosure or some methods in the related art.

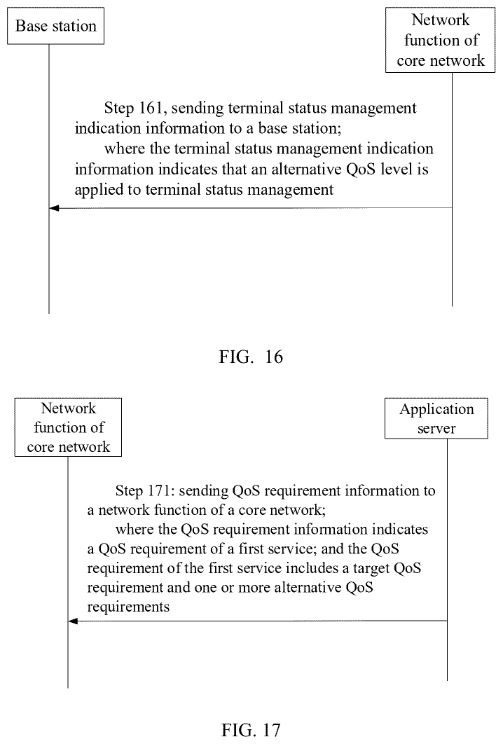

As shown in FIG. 16, an embodiment provides a wireless communication method, performed by a network function of a core network, including a following step.

Step 161, sending terminal status management indication information to a base station; where the terminal status management indication information indicates that an alternative QoS level is applied to terminal status management.

In an embodiment, terminal status management indication information is sent to the base station, where the terminal status management indication information indicates that an alternative QoS level is applied to terminal status management. It should be noted that the terminal status management indication information may be generated by a policy control function (PCF), the terminal status management indication information is used as a parameter in the alternative QoS in the policy and charging control (PCC) rule, the PCF sends the terminal status management indication information to a session management function (SMF), and the SMF sends the terminal status management indication information to the base station.

It should be noted that those skilled in the art may understand that the method provided by the embodiments of the present disclosure may be performed independently, or may be performed together with some methods in the embodiments of the present disclosure or some methods in the related art.

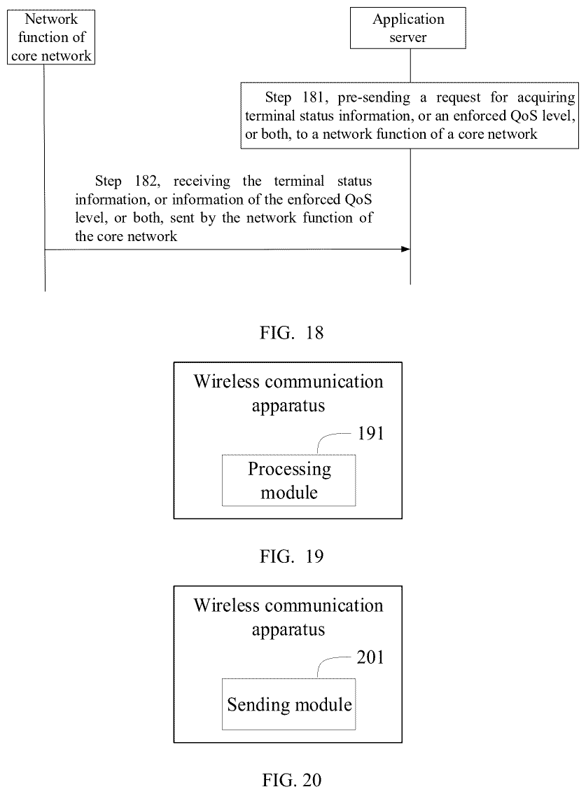

As shown in FIG. 17, an embodiment provides a wireless communication method, performed by an application server, including step 171.

Step 171: sending QoS requirement information to a network function of a core network; where the QoS requirement information indicates a QoS requirement of a first service; and the QoS requirement of the first service includes a target QoS requirement and one or more alternative QoS requirements.

In an embodiment, the QoS requirement information is sent to the network function of the core network; where the QoS requirement information indicates a QoS requirement of the first service, and the QoS requirement of the first service includes a target QoS requirement and one or more alternative QoS requirements. The network function of the core network determines the QoS level of the first service based on the QoS requirement indicated by the QoS requirement information, where the QoS level of the first service includes a target QoS level and one or more alternative QoS levels. The network function of the core network sends the QoS level information of the QoS flow bound to the first service to the base station; where the QoS level information indicates target QoS and alternative QoS; and the QoS level information is used by the base station to enforce, based on terminal status information, a QoS level of a first service corresponding to the terminal status information.

It should be noted that those skilled in the art may understand that the method provided by the embodiments of the present disclosure may be performed independently, or may be performed together with some methods in the embodiments of the present disclosure or some methods in the related art.

As shown in FIG. 18, an embodiment provides a wireless communication method, performed by an application server, including steps 181-182.

Step 181, pre-sending a request for acquiring terminal status information, or an enforced QoS level, or both, to a network function of a core network; Step 182, receiving the terminal status information, or information of the enforced QoS level, or both, sent by the network function of the core network.

In an embodiment, the QoS requirement information is sent to the network function of the core network; where the QoS requirement information indicates a QoS requirement of the first service, and the QoS requirement of the first service includes a target QoS requirement and one or more alternative QoS requirements. The request for acquiring the terminal status information, or the currently enforced QoS level, or both, is pre-sent to the network function of the core network; and the current terminal status information of the terminal, or the information of the currently enforced QoS level sent by the network function of the core network is received. “The request for acquiring the terminal status information, or the currently enforced QoS level, or both, is pre-sent to the network function of the core network” herein can be understood as “the terminal status information, or the currently enforced QoS level, or both, is subscribed from the network function of the core network”.

It should be noted that those skilled in the art may understand that the method provided by the embodiments of the present disclosure may be performed independently, or may be performed together with some methods in the embodiments of the present disclosure or some methods in the related art.

As shown in FIG. 19, an embodiment provides a wireless communication apparatus, including: a processing module 191, configured to: enforce, according to terminal status information of a terminal, a quality of service (QoS) level of a first service corresponding to the terminal status information; where the terminal status information indicates a terminal status.

It should be noted that those skilled in the art may understand that the method provided by the embodiments of the present disclosure may be performed independently, or may be performed together with some methods in the embodiments of the present disclosure or some methods in the related art.

As shown in FIG. 20, an embodiment provides a wireless communication apparatus, including: a sending module 201, configured to send terminal status information of a terminal to a base station; where the terminal status information indicates a terminal status, and is used by the base station to enforce a quality of service (QoS) level of a first service corresponding to the terminal status information.

It should be noted that those skilled in the art may understand that the method provided by the embodiments of the present disclosure may be performed independently, or may be performed together with some methods in the embodiments of the present disclosure or some methods in the related art.

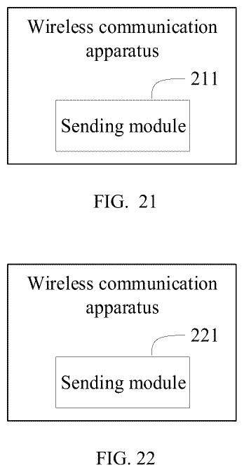

As shown in FIG. 21, an embodiment provides a wireless communication apparatus, including: a sending module 211, configured to send quality of service (QoS) level information of a QoS flow bound to a predetermined service flow to a base station; where the QoS level information indicates target QoS and alternative QoS; and the QoS level information is used by the base station to enforce, based on terminal status information, a QoS level of a first service corresponding to the terminal status information.

It should be noted that those skilled in the art may understand that the method provided by the embodiments of the present disclosure may be performed independently, or may be performed together with some methods in the embodiments of the present disclosure or some methods in the related art.

As shown in FIG. 22, an embodiment provides a wireless communication apparatus, including: a sending module 221, configured to send quality of service (QoS) requirement information to a network function of a core network; where the QoS requirement information indicates a QoS requirement of a first service.

It should be noted that those skilled in the art may understand that the method provided by the embodiments of the present disclosure may be performed independently, or may be performed together with some methods in the embodiments of the present disclosure or some methods in the related art.

An embodiment of the present disclosure provides a communication device, including: a processor; and a memory for storing an instruction executable by the processor; where the processor is configured to execute the executable instruction to implement the method applied to any embodiment of the present disclosure.

The processor may include various types of storage medium, and the storage medium are non-transitory computer storage medium that can maintain memorized information stored thereon when the communication device is powered off.

The processor may be connected to the memory through a bus or the like, and is configured to read an executable program stored in the memory.

An embodiment of the present disclosure further provides a computer storage medium, where the computer storage medium stores a computer-executable program, and when the executable program is executed by a processor, the method of any embodiment of the present disclosure is implemented.

Regarding the apparatus in the above embodiments, specific manners for each module to perform operations have been described in detail in the embodiments related to the method, which will not be repeated in detail herein.

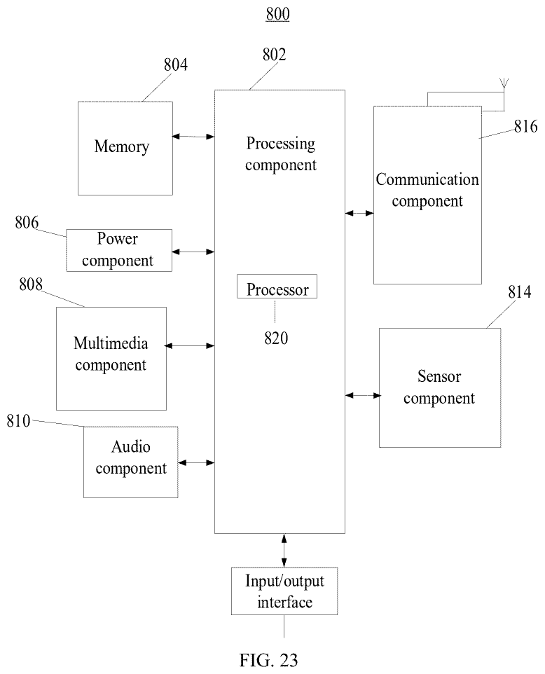

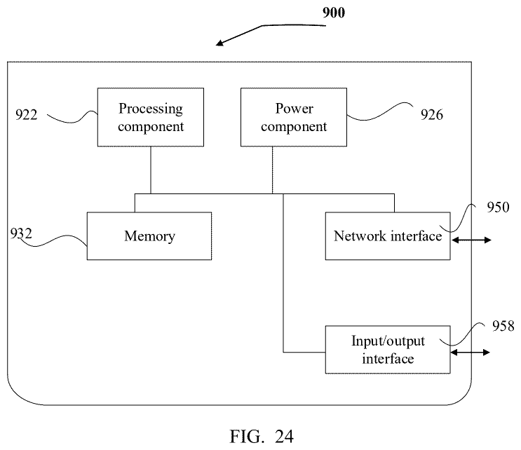

As shown in FIG. 23, an embodiment of the present disclosure provides a structure of a terminal.

Referring to a terminal 800 shown in FIG. 23, an embodiment provides a terminal 800, and the terminal may be specifically a mobile phone, a computer, a digital broadcast terminal, a messaging device, a game console, a tablet device, a medical device, exercise equipment, a personal digital assistant, or the like.

Referring to FIG. 23, the terminal 800 may include one or more of following components: a processing component 802, a memory 804, a power component 806, a multimedia component 808, an audio component 810, an input/output (I/O) interface 812, a sensor component 814, and a communication component 816.

The processing component 802 generally controls overall operations of the terminal 800, such as operations associated with display, telephone calls, data communications, camera operations, and recording operations. The processing component 802 may include one or more processors 820 to execute instructions to perform all or part of the steps of the above method. In addition, the processing component 802 may include one or more modules to facilitate interaction between the processing component 802 and other components. For example, the processing component 802 may include a multimedia module to facilitate interaction between the multimedia component 808 and the processing component 802.

The memory 804 is configured to store various types of data to support operations at the terminal 800. Examples of such data include instructions for any application or method, contact data, phonebook data, messages, pictures, videos, etc., operating on the terminal 800. The memory 804 may be implemented by any type of volatile or non-volatile storage device or a combination thereof, such as static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disks.

The power component 806 provides power to various components of the terminal 800. The power component 806 may include a power management system, one or more power sources, and other components associated with generating, managing, and distributing power for the terminal 800.

The multimedia component 808 includes a screen providing an output interface between the terminal 800 and the user. In some embodiments, the screen may include a liquid crystal display (LCD) and a touch panel (TP). If the screen includes a touch panel, the screen may be implemented as a touch screen to receive input signals from a user. The touch panel includes one or more touch sensors to sense touches, swipes, and gestures on the touch panel. The touch sensor may not only sense a boundary of a touch or slide action, but also detect a duration and pressure associated with the touch or slide operation. In some embodiments, the multimedia component 808 includes a front camera and/or a rear camera. When the apparatus 800 is in an operation mode, such as a photographing mode or a video mode, the front camera and/or the rear camera may receive external multimedia data. Each of the front camera and the rear camera may be a fixed optical lens system or have focal length and optical zoom capability.

The audio component 810 is configured to output and/or input audio signals. For example, the audio component 810 includes a microphone (MIC) configured to receive an external audio signal when the terminal 800 is in an operation mode, such as a call mode, a recording mode, and a voice recognition mode. The received audio signal may be further stored in the memory 804 or transmitted via the communication component 816. In some embodiments, the audio component 810 further includes a speaker configured to output an audio signal.

The I/O interface 812 provides an interface between the processing component 802 and peripheral interface modules, which may be keyboards, click wheels, buttons, etc. These buttons may include, but are not limited to, home buttons, volume buttons, start buttons, and lock buttons.

The sensor component 814 includes one or more sensors for providing status assessments of various aspects of the terminal 800. For example, the sensor component 814 may detect an open/closed state of the terminal 800, relative positioning of components, such as a display and a keypad of the terminal 800, a position change of the terminal 800 or a component of the terminal 800, a presence or absence of user contact with the terminal 800, an orientation or acceleration/deceleration of the terminal 800, and a temperature change of the terminal 800. The sensor component 814 may include a proximity sensor configured to detect, without any physical contact, the presence of nearby objects. The sensor component 814 may also include alight sensor, such as a CMOS (Complementary Metal-Oxide-Semiconductor) or CCD (Charge Coupled Device) image sensor, for use in imaging applications. In some embodiments, the sensor component 814 may further include an acceleration sensor, a gyroscope sensor, a magnetic sensor, a pressure sensor, or a temperature sensor.

The communication component 816 is configured to facilitate wired or wireless communication between the terminal 800 and other devices. The terminal 800 may access a wireless network based on a communication standard, such as Wi-Fi, 2G, or 3G, or a combination thereof. In an example embodiment, the communication component 816 receives a broadcast signal or broadcast related information from an external broadcast management system via a broadcast channel. In an example embodiment, the communication component 816 also includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an example embodiment, the terminal 800 may be implemented by one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, and is configured to perform the above methods.

In an example embodiment, there is further provided a non-transitory computer-readable storage medium including an instruction, such as a memory 804 including the instruction, where the instruction is executable by a processor 820 of the terminal 800 to perform the above method. For example, a non-transitory computer-readable storage medium may be a ROM, a random access memory (RAM), CD-ROM, magnetic tape, floppy disk, optical data storage device, and the like.

As shown in FIG. 24, an embodiment of the present disclosure provides a structure of a base station. For example, the base station 900 may be provided as a network side device. Referring to FIG. 24, the base station 900 includes a processing component 922, which further includes one or more processors, and memory resources represented by a memory 932 for storing instructions executable by the processing component 922, such as an application program. The application program stored in the memory 932 may include one or more modules each corresponding to a set of instructions. In addition, the processing component 922 is configured to execute instructions to perform any method applied to the base station as described above.

The base station 900 may further include a power component 926 configured to perform power management of the base station 900, a wired or wireless network interface 950 configured to connect the base station 900 to a network, and an input/output (I/O) interface 958. The base station 900 may operate based on an operating system stored in the memory 932, such as Windows Server™, Mac OS X™, Unix™, Linux™, Free BSD™, or the like.

Other embodiments of the present disclosure will easily occur to those skilled in the art after considering the specification and practicing the present disclosure herein. The present disclosure is intended to cover any variations, uses or adaptations of the present disclosure, which follow the general principles of the present disclosure and include common sense or common technical means in this technical field that are not disclosed in the present disclosure. The specification and examples are to be regarded as examples only, with the true scope and spirit of the present disclosure being indicated by the following claims.

It should be understood that the present disclosure is not limited to the precise structures described above and shown in the accompanying drawings, and various modifications and changes may be made without departing from the scope thereof. The scope of the present disclosure is limited only by the appended claims.

1. A wireless communication method, performed by a base station, comprising:
enforcing, according to terminal status information of a terminal, a quality of service (QoS) level of a first service corresponding to the terminal status information.

2. The method according to claim 1, wherein enforcing, according to the terminal status information, the QoS level of the first service corresponding to the terminal status information comprises:
enforcing the QoS level of the first service corresponding to the terminal status information according to the terminal status information and a mapping relationship between the terminal status and the QoS level indicated by the terminal status information.

3. The method according to claim 2, wherein the mapping relationship comprises a relationship between the terminal status, a screen refresh rate, the QoS level, and a coding scheme for application data flows.

4. The method according to claim 1, further comprising:
receiving the terminal status information.

5. The method according to claim 4, wherein enforcing, according to the terminal status information, the QoS level of the first service corresponding to the terminal status information comprises:
in response to receiving the terminal status information, enforcing, according to the terminal status information, the QoS level of the first service corresponding to the terminal status information; or,
in response to receiving the terminal status information and determining that a preset number of resources is less than a threshold, enforcing, according to the terminal status information, the QoS level of the first service corresponding to the terminal status information; or
in response to receiving the terminal status information and determining that a required preset number of resources is greater than a threshold, enforcing, according to the terminal status information, the QoS level of the first service corresponding to the terminal status information.

6. The method according to claim 1, further comprising:
in response to changing of the terminal status information or changing of the QoS level of the first service, sending the terminal status information, or information of the enforced QoS level, or both, to a core network; or,
in response to changing of the QoS level of the first service, sending information of the enforced QoS level to the terminal.

7. The method according to claim 1, further comprising:
receiving QoS level information sent by a core network;
wherein the QoS level information indicates target QoS and alternative QoS of a QoS flow bound to the first service.

8. The method according to claim 7, wherein enforcing, according to the terminal status information of the terminal, the QoS level of the first service corresponding to the terminal status information comprises:
modifying the QoS level of the first service from the target QoS to the alternative QoS according to the terminal status information of the terminal; or,
modifying the QoS level of the first service from the alternative QoS to the target QoS according to the terminal status information of the terminal; or,
modifying the QoS level of the first service from one alternative QoS to another alternative QoS according to the terminal status information of the terminal.

9. The method according to claim 1, further comprising:
receiving terminal status management indication information sent by a core network;
wherein the terminal status management indication information indicates that an alternative QoS level is applied to terminal status management.

10. The method according to claim 1, wherein the terminal status information comprises at least one of:
battery level information;
heating level information; or
central processing unit (CPU) load information.

11-13. (canceled)

14. A wireless communication method, performed by a core network, comprising:
sending quality of service (QoS) level information of a QoS flow bound to a first service to a base station;
wherein the QoS level information indicates target QoS and alternative QoS; and
the QoS level information is used by the base station to enforce, based on terminal status information, a QoS level of a first service corresponding to the terminal status information.

15. The method according to claim 14, further comprising:
receiving QoS requirement information sent by an application server;
wherein the QoS requirement information indicates a QoS requirement of the first service; and the QoS requirement of the first service comprises a target QoS requirement and one or more alternative QoS requirements.

16. The method according to claim 15, further comprising:
determining the QoS level of the first service based on the QoS requirement indicated by the QoS requirement information, wherein the QoS level of the first service comprises a target QoS level and one or more alternative QoS levels.

17. The method according to claim 14, further comprising:
receiving the terminal status information, or information of the enforced QoS level, or both.

18. The method according to claim 17, further comprising:
in response to pre-receiving a request for acquiring the terminal status information, or the QoS level, or both, sent by an application server, sending the terminal status information, or the information of the enforced QoS level, or both, to the application server.

19. The method according to claim 14, further comprising:
sending terminal status management indication information to the base station;
wherein the terminal status management indication information indicates that an alternative QoS level is applied to terminal status management.

20. The method according to claim 14, wherein the terminal status information comprises at least one of:
battery level information;
heating level information; or
central processing unit (CPU) load information.

21-26. (canceled)

27. A communication device, comprising:
a memory;
a processor, coupled to the memory and configured to execute a computer-executable instruction stored on the memory to implement the method according to claim 1.

28. (canceled)

29. A communication device, comprising:
a memory;
a processor, coupled to the memory and configured to execute a computer-executable instruction stored on the memory to implement the method according to claim 14.
